(19) United States
(12) Patent Application Publication
(10) Pub. No.: US 2019/0050963 A1
(43) Pub. Date: Feb. 14, 2019

(54) TRANSMISSION METHOD OF DISPLAY DATA, APPARATUS AND MOBILE DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Xiurong WANG, Beijing (CN); Wei SUN, Beijing (CN); Xue DONG, Beijing (CN); Lingyun SHI, Beijing (CN); Dong CHEN, Beijing (CN); Xiaochuan CHEN, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/047,288

(22) Filed: Jul. 27, 2018

(30) Foreign Application Priority Data
Aug. 11, 2017 (CN) 201710685412.7

(51) Int. Cl. G06T 3/40; G09G 5/00

(52) U.S. Cl. CPC G06T 3/4092; G09G 2360/16; G09G 2340/0407; G09G 5/003

(57) ABSTRACT

There are proposed in the present disclosure a transmission method of display data, an apparatus and a mobile device. The method includes: performing statistics on a number of pixel points in the display data based on grayscale; adjusting an initial output resolution according to a result obtained from the statistics; transmitting the display data according to an adjusted output resolution. The present disclosure is capable of reducing system power consumption of the mobile device effectively.

The present application claims the priority of a Chinese patent application No. 201710685412.7 filed on Aug. 11, 2017, with an invention title of TRANSMISSION METHOD OF DISPLAY DATA, APPARATUS AND MOBILE DEVICE. Herein, the content disclosed by the Chinese patent application is incorporated in full by reference as a part of the present disclosure.

### TECHNICAL FIELD

The present disclosure relates to a technical field of a mobile device, in particular to a transmission method of display data, an apparatus and a mobile device.

### BACKGROUND

In related technique, it generally adopts a same resolution to transmit display data in a mobile device. However, a screen of the mobile device does not need to always maintain a high resolution in certain scenarios.

### SUMMARY

There is provided in the present disclosure a transmission method of display data, which is capable of reducing system power consumption for the mobile device effectively, a transmission apparatus of display data of the same, a non-transitory computer readable storage medium, a computer program product and a mobile device.

According to first aspect of the present disclosure, there is provided the transmission method of the display data, comprising: performing statistics on the number of pixel points for the display data based on grayscale; adjusting an initial output resolution according to a result obtained from the statistics; transmitting the display data according to an adjusted output resolution.

The transmission method of the display data proposed in the embodiment of the first aspect of the present disclosure performs statistics on the number of the pixel points for the display data based on the grayscale, adjusts the initial output resolution according to the result obtained from the statistics, and transmits the display data according to the adjusted output resolution, which is capable of reducing effectively the system power consumption for the mobile device.

According to second aspect of the present disclosure, there is provided the transmission apparatus of the display data comprising: a statistical module, configured to perform statistics on the number of pixel points for the display data based on grayscale; an adjusting module, configured to adjust an initial output resolution according to a result obtained from the statistics; a transmission module, configured to transmit the display data according to an adjusted output resolution.

The transmission apparatus of the display data proposed in the embodiment of the second aspect of the present disclosure performs statistics on the number of the pixel points for the display data based on the grayscale, adjusts the initial output resolution according to the result obtained from the statistics, and transmits the display data according to the adjusted output resolution, which is capable of reducing effectively the system power consumption of the mobile device.

According to third aspect of the present disclosure, there is provided the non-transitory computer readable storage medium. When instructions in the storage medium are executed by a processor of a mobile terminal, it makes that the mobile terminal is capable of executing a transmission method of the display data. The method comprises: performing statistics on the number of pixel points for display data based on grayscale; adjusting an initial output resolution according to a result obtained from the statistics; transmitting the display data according to an adjusted output resolution.

The non-transitory computer storage medium proposed in the embodiment of the third aspect of the present disclosure performs statistics on the number of the pixel points for the display data based on the grayscale, adjusts the initial output resolution according to the result obtained from the statistics, and transmits the display data according to the adjusted output resolution, which is capable of reducing the system power consumption of the mobile device effectively.

According to fourth aspect of the present disclosure, there is provided the computer program product. When instructions in the computer program product are executed by a processor, a transmission data of display data is executed, the method comprises: performing statistics on the number of pixel points for display data based on grayscale; adjusting an initial output resolution according to a result obtained from the statistics; transmitting the display data according to an adjusted output resolution.

The computer program product proposed in the embodiment of the fourth aspect of the present disclosure performs statistics on the number of the pixel points for the display data based on the grayscale, adjusts the initial output resolution according to the result obtained from the statistics, and transmits the display data according to the adjusted output resolution, which is capable of reducing effectively the system power consumption of the mobile device.

According to fifth aspect of the present disclosure, there is provided the mobile device. The mobile device comprises a housing, a processor, a memory, a circuit board and a power supply circuit, wherein the circuit board is disposed inside a space surrounded by the housing, and the processor and the memory are disposed on the circuit board; the power supply circuit is configured to supply electric for each circuit or device of the mobile device; the memory is configured to store executable program code; the memory runs a program corresponding to an executable program code stored in the memory by reading the executable program code, so as to be used to execute: performing statistics on a number of pixel points for the display data based on grayscale; adjusting an initial output resolution according to a result obtained from the statistics; transmitting the display data according to an adjusted output resolution.

The mobile device proposed in the embodiment of the fifth aspect of the present disclosure performs statistics on the number of the pixel points for the display data based on the grayscale, adjusts the initial output resolution according to the result obtained from the statistics, and transmits the display data according to the adjusted output resolution, which is capable of reducing the system power consumption of the mobile device effectively.

Additional aspects and advantages of the present disclosure will be given below in the following description. A part of the aspects and advantages will become obvious from the following description, or will be known from the practice of the present disclosure.

### BRIEF DESCRIPTION OF THE DRAWINGS

The above and/or additional aspects and advantages of the present disclosure will become obvious and easy to be understood from the following description of embodiments in combination with the figures, wherein:

FIG. 1 is a flow schematic diagram of a transmission method of display data provided in one embodiment of the present disclosure;

FIG. 2 is a flow schematic diagram of a transmission method of display data proposed in another embodiment of the present disclosure;

FIG. 3 is a structure schematic diagram of a transmission apparatus of display data proposed in one embodiment of the present disclosure;

FIG. 4 is a structure schematic diagram of a transmission apparatus of display data proposed in another embodiment of the present disclosure;

FIG. 5 is a structure schematic diagram of a mobile device proposed in an embodiment of the present disclosure.

### DETAILED DESCRIPTION

Embodiments of the present disclosure will be described below in detail. Examples of the embodiments described below are shown in the figures, wherein reference marks same or similar all along represent same or similar elements or elements having same or similar functions. The embodiments described below by referring to the figures are for illustration and just used for explaining the present disclosure, instead of being understood as limitation to the present disclosure. On the contrary, the embodiments of the present disclosure comprise all changes, modifications and equivalents that fall into the scope of the spirit and content of the Claims.

FIG. 1 is a flow schematic diagram of a transmission method of display data proposed in one embodiment of the present disclosure.

This embodiment is described by taking an example in which the transmission method of display data is configured in a transmission apparatus of display data.

The transmission method of the display data in the embodiment can be configured in the transmission apparatus of the display data. The transmission apparatus of the display data can be disposed in a server, or can be disposed in a mobile device, to which the present disclosure does not limit.

The present embodiment takes the transmission apparatus of the display data being configured in the mobile device as an example.

The transmission apparatus of the display data can perform variable resolution transmission on data displayed on the mobile device.

The mobile device can be a hardware device having various operation systems such as a smartphone, a tablet computer, a personal digital assistant, an electronic book, etc.

By referring to FIG. 1, this method comprises:

S101: performing statistics on the number of pixel points in the display data based on grayscale.

Herein, the grayscale refers to a level of shades that surface feature electromagnetic wave radiation intensity is represented on a black-white image, and it is a scale for dividing surface feature spectrum character.

The display data can be particularly data of a current frame of picture to be displayed in a mobile device.

It can be understood that the data of the current frame of picture to be displayed can be transmitted before being displayed. For example, the data is transmitted from a server terminal to a mobile device terminal, and is transmitted to a display screen via an interface of the mobile device used for receiving data.

In related art, the display data is generally transmitted by using a same resolution. However, the screen of the mobile device does not need to be always maintained at a high resolution in certain scenarios.

Therefore, there is proposed in the embodiment of the present disclosure to perform variable resolution transmission on the data displayed on the mobile device.

Generally, in a display picture corresponding to display data, grayscale for different pixel points are different. Therefore, for different display data, distribution of grayscale of all the pixel points in respective display data is also different. Therefore, statistics can be performed on the number of the pixel points in the display data based on the grayscale.

S102: adjusting an initial output resolution according to a result obtained from the statistics.

The initial output resolution may be a default resolution of the mobile device, or may be a resolution designated by a user for the mobile device, to which no limitation is made.

In the embodiment of the present disclosure, a grayscale threshold value can be set. Further, statistics are performed on the number of the pixel points in the display data whose grayscale value is greater than the grayscale threshold value, and statistics are performed on the number of the pixel points in the display data whose grayscale value is smaller than or equal to the grayscale threshold value, to obtain a statistical result.

Optionally, performing statistics on the number of the pixel points in the display data based on grayscale comprises: counting the number of pixels in the display data whose grayscale is smaller than or equal to the first grayscale threshold value, to obtain a first count; counting the number of pixels in the display data whose grayscale is greater than the first grayscale threshold value and smaller than or equal to a second grayscale threshold value, to obtain a second count, wherein the first grayscale threshold value is smaller than the second grayscale threshold value; counting the number of pixels in the display data whose grayscale is greater than the second grayscale threshold, to obtain a third count.

Herein, the first grayscale threshold value/the second grayscale threshold value can be predetermined.

The first scale gray threshold value/second grayscale threshold value can be set by factory programs of the mobile device in advance, or can be set by the user according to his/her own requirements, to which no limitation is made.

In the embodiment of the present disclosure, when statistical results belong to different statistical cases, different adjustments can be made to the initial output resolution.

S103: transmitting the display data according to an adjusted output resolution.

In the embodiment of the present disclosure, since statistics are performed on the number of the pixel points in the display data based on the grayscale, human eyes' physiological characteristics of being sensitive to the brightness can be utilized, in particular, a pixel grayscale statistical unit can be pre-configured in the mobile device to perform statistics on the number of the pixel points in the display data and distinguish the cases that do not need to display with a high resolution according to the statistical result, so as to change the resolution dynamically, change the amount of data transmitted from AP system in the mobile device to a TFT-LCD, thereby reducing the power consumption of the mobile device terminal system.

In the embodiment, by performing statistics on the number of the pixel points in the display data based on the grayscale, adjusting the initial output resolution according to the result obtained from the statistics, and transmitting the display data according to the adjusted output resolution, it is capable of reducing the system power consumption of the mobile device effectively.

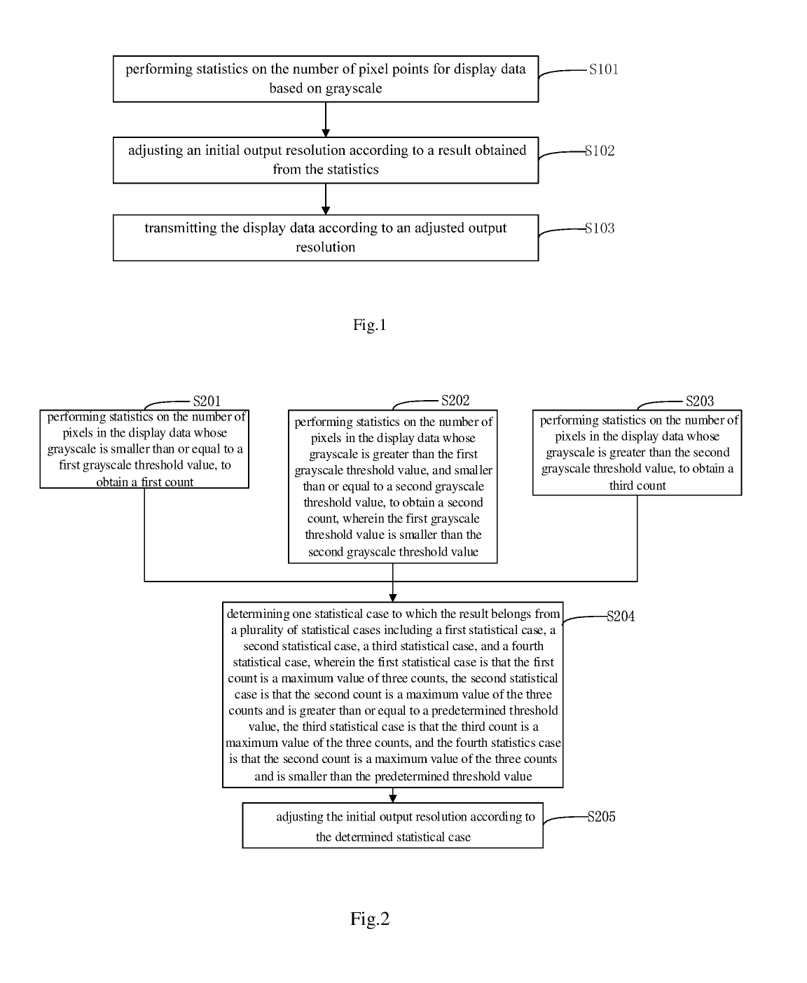

FIG. 2 is a flow schematic diagram of a transmission method of display data proposed in another embodiment of the present disclosure.

By referring to FIG. 2, the method comprises:

S201: counting the number of pixels in the display data whose grayscale is smaller than or equal to the first grayscale threshold value, to obtain a first count.

S202: counting the number of pixels in the display data whose grayscale is greater than the first grayscale threshold value and smaller than or equal to the second pixel gray threshold value, to obtain a second count, wherein the first grayscale threshold value is smaller than the second grayscale threshold value.

S203: counting the number of pixels in the display data whose grayscale is greater than the second grayscale threshold value, to obtain a third count.

Herein, a pixel grayscale statistical unit can be pre-configured in the mobile device, three counters are configured in the pixel grayscale statistical unit, and the three counters perform statistics on the number of the pixel points in the display data that have different grayscale values respectively.

For example, it can be assumed that the first grayscale threshold value is b, and the second grayscale value is a, wherein a is greater than b. Grayscale of all the pixel points in the data to be displayed currently can be traversed, and when grayscale of a pixel point is greater than a, a count value of a counter Counter_A is incremented by 1; when the grayscale is smaller than or equal to b, a count value of a counter Counter_C is incremented by 1; when the grayscale is between a and b, a count value of a counter Counter_B is incremented by 1. After the traversal ends up, the count value in the Counter_A is the number of the pixel points in the display data whose grayscale is greater than a, the count value in the Counter_B is the number of the pixel points in the image whose grayscale is greater than b and smaller than or equal to a, and the count value in the Counter_C is the number of the pixel points in the image whose grayscale is smaller than or equal to b.

Correspondingly, the count value in the Counter_C is a first count, the count value in the Counter_B is a second count, and the count value in the Counter_A is a third count.

S204: determining one statistical case, to which the result belongs, among a plurality of statistical cases, wherein the plurality of statistical cases include: a first statistical case, a second statistical case, a third statistical case, and a fourth statistical case. The first statistical case is that the first count is the maximum value of the three counts; the second statistical case is that the second count is the maximum value of the three counts and the second count is greater than or equal to a predetermined threshold value; the third statistical case is that the third count is the maximum value of the three counts; and the fourth statistical case is that the second count is the maximum value of the three counts and the second count is smaller than the predetermined threshold value.

Optionally, the predetermined threshold value is a product of a predetermined percentage value and the number of total pixels of the display data.

Optionally, the predetermined percentage value is ⅔.

S205: adjusting the initial output resolution according to the determined statistical case.

Optionally, the step of adjusting the initial output resolution according to the determined statistical case comprises: if the result is the first statistical case, the initial output resolution is adjusted into a first predetermined output resolution, and takes the first predetermined output resolution as an adjusted output resolution; if the result is the second statistical case, then the initial output resolution is not adjusted; if the result is the third statistical case, the initial output resolution is not adjusted; if the result is the fourth statistical case, the initial output resolution is adjusted into a second predetermined output resolution, and the second predetermined output resolution is taken as an adjusted output resolution.

Optionally, the initial output resolution is greater than the first predetermined output resolution or the second predetermined output resolution.

The first predetermined output resolution and the second predetermined output solution may be same or may be different.

For example, the AP system in the mobile device can compare and judge the size of the count values in the Counter_A, Counter_B, and Counter_C. When the count value of the Counter_A is the maximum value, that is, in all the pixel points of the display data corresponding to one image, the amount of the pixel points with grayscale greater than a is relatively lager, the AP system of the mobile device is set to output the display data with the initial output resolution, and usually this initial output resolution is a relatively high resolution. When the count value in the Counter_C is the maximum value, that is, in all the pixel points of the display data corresponding to one image, the amount of the pixel points with grayscale smaller than or equal to b is relatively lager, the AP system of the mobile device is set to transmit the display data by reducing the resolution, for example, adjusting the initial output resolution to the first predetermined output resolution which is pre-determined and smaller than the initial output resolution. When the count value in the Counter_B is the maximum value, and the count value in the Counter_B is greater than or equal to ⅔ of the number of total pixels of the display data, that is, in all the pixel points of the display data corresponding to one image, the amount of the pixel points with grayscale falling between the grayscale a and the grayscale b is relatively large, the initial output resolution is not adjusted. When the count value in the Counter_B is the maximum value, and the count value in the Counter_B is smaller than ⅔ of the number of total pixels of the display data, the initial output resolution can be adjusted to the second predetermined output resolution which is pre-determined and smaller than the initial output resolution.

Further, when the counter value in the Counter_B is the maximum value, and the counter value in the Counter_B is greater than or equal to ⅔ of the number of total pixels of the display data, that is, in all the pixel points of the display data corresponding to one image, the amount of the pixel points with grayscale falling between the grayscale a and the grayscale b is relatively large, a judgement may be made by detail information on the image. If there is little detail information on the image, the AP system of the mobile device is set to transmit the display data by reducing the resolution; otherwise, transmission of the display data is performed with the initial output resolution.

In the embodiment, by performing statistics on the number of pixel points in the display data based on the grayscale, adjusting the initial output resolution according to the result obtained from the statistics, and transmitting the display data according to the adjusted output resolution, it is capable of reducing the system power consumption for the mobile device effectively. By determining the statistical case to which the result belongs and adjusting the initial output resolution according to the determined statistical case, it is capable of adjusting the output resolution according to the actual situations, so that the display effect of the display data is guaranteed effectively while the adjustment flexibility is improved.

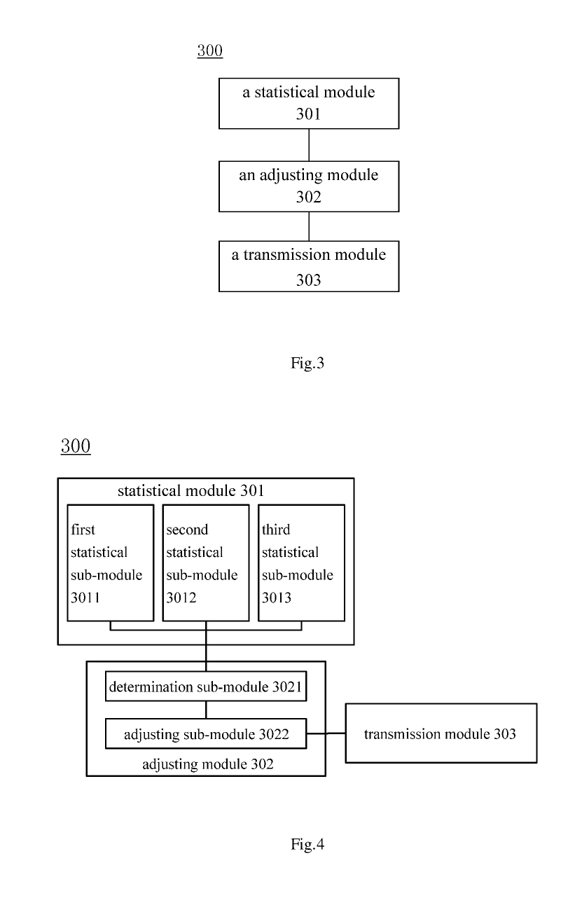

FIG. 3 is a structure schematic diagram of a transmission apparatus of display data proposed in an embodiment of the present disclosure.

By referring to FIG. 3, an apparatus 300 comprises: a statistical module 301, an adjusting module 302, and a transmission module 303.

The statistical module 301 is configured to perform statistics on the number of pixel points in the display data based on grayscale.

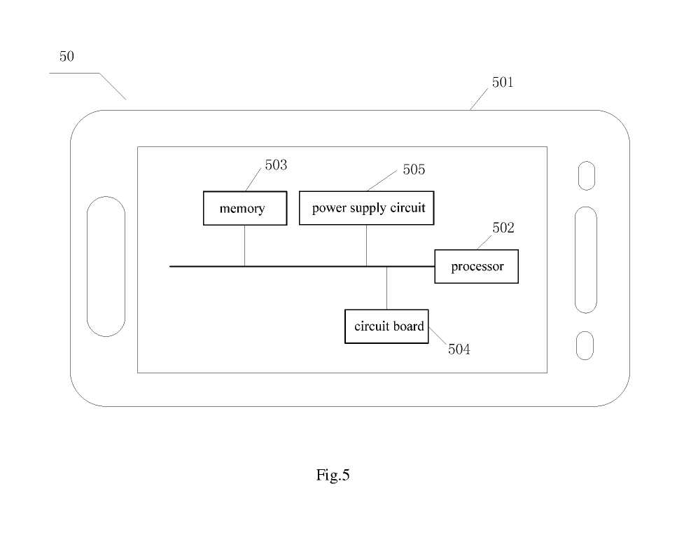

Optionally, in some embodiments, by referring to FIG. 4, the statistical module 301 comprises:

a first statistical sub-module 3011, configured to perform statistics on the number of pixels in the display data whose grayscale is smaller than or equal to a first grayscale threshold value, to obtain a first count;

a second statistical sub-module 3012, configured to perform statistics on the number of pixels in the display data whose grayscale is greater than the first grayscale threshold value, and smaller than or equal to a second grayscale threshold value, to obtain a second count, wherein the first grayscale threshold value is smaller than the second grayscale threshold; and

a third statistical sub-module 3013, configured to perform statistics on the number of pixels in the display data whose grayscale is greater than the second grayscale threshold value, to obtain a third count.

The adjusting module 302 is configured to adjust the initial output resolution according to a result obtained from the statistics.

Optionally, in some embodiments, by referring to FIG. 4, the adjusting module 302 comprises a determination sub-module 3021 and an adjusting sub-module 3022.

The determination sub-module 3021 is configured to determine one statistical case, to which the result belongs, among a plurality of statistical cases, wherein the plurality of statistical cases include: a first statistical case, a second statistical case, a third statistical case, and a fourth statistical case. The first statistical case is that the first count is the maximum value of the three counts; the second statistical case is that the second count is the maximum value of the three counts and the second count is greater than or equal to a predetermined threshold value; the third statistical case is that the third count is the maximum value of the three counts; and the fourth statistical case is that the second count is the maximum value of the three counts and the second count is smaller than the predetermined threshold value.

Optimally, the predetermined threshold value is a product of a predetermined percentage value and the number of total pixels of the display data.

Optionally, the predetermined percentage value is ⅔.

The adjusting sub-module 3022 is configured to adjust the initial output resolution according to the determined statistical case.

Optionally, in some embodiments, the adjusting sub-module 3022 is particularly configured to:

adjust the initial output resolution into the predetermined output resolution and takes the predetermined output resolution as an adjusted output resolution if the result is the first statistical case;

not adjust the initial output resolution if the result is the second statistical case;

not adjust the initial output resolution if the result is the third statistical case;

adjust the initial output resolution into the predetermined output resolution and take the predetermined output resolution as the adjusted output resolution if the result is the fourth statistical case.

Optionally, the initial output resolution is greater than the predetermined output resolution.

The transmission module 303 is configured to transmit the display data according to the adjusted output resolution.

It needs to note that explanations and descriptions about the transmission method of the display data in the embodiments of FIGS. 1 and 2 are also applicable to the transmission apparatus 300 of the display data in this embodiment, and its implementation principle is similar, and thus no further description is given herein.

In the present embodiment, by performing statistics on the number of pixel points in the display data based on the grayscale, adjusting the initial output resolution according to the result obtained from the statistics, and transmitting the display data according to the adjusted output resolution, it is capable of reducing the system power consumption for the mobile device.

FIG. 5 is a structure schematic diagram of a mobile device proposed in an embodiment of the present disclosure.

The mobile device can for example be a mobile phone, a tablet computer and the like.

By referring to FIG. 5, a mobile device 50 of this embodiment comprises: a housing 501, a processor 502, a memory 503, a circuit board 504, and a power supply circuit 505, wherein the circuit board 504 is arranged inside the space surrounded by the housing 501, and the processor 502 and the memory 503 are disposed on the circuit board 504; the power supply circuit 505 is configured to supply power for respective circuits or devices for the mobile device 50; the memory 503 is configured to store executable program codes. The processor 502 runs programs corresponding to the executable program codes by reading out the executable program codes stored in the memory, to be used for executing following:

performing statistics on the number of pixel points in display data based on grayscale;

adjusting an initial output resolution according to a result obtained from the statistics;

transmitting the display data according to the adjusted output resolution.

It needs to note that the explanations and descriptions about the transmission method of the display data in the embodiments of FIGS. 1 and 2 are also applicable to the mobile device 50 of the embodiment, and its implementation principle is similar, and thus no further description is given herein.

By performing statistics on the number of pixel points in the display data based on the grayscale, adjusting the initial output resolution according to the result obtained from the statistics, and transmitting the display data according to the adjusted output resolution, the mobile device in the embodiment is capable of reducing the system power consumption for the mobile device effectively.

In order to realize the above embodiment, there is further proposed in the present disclosure a non-transitory computer readable storage medium. When instructions in the storage medium are executed by a processor of a terminal, the terminal is enabled to execute a transmission method of display data, the method comprising: performing statistics on the number of the pixel points in the display data based on grayscale; adjusting an initial output resolution according to a result obtained from the statistics; transmitting the display data according to an adjusted output resolution.

By performing statistics on the number of pixel points in the display data based on the grayscale, adjusting the initial output resolution according to the result obtained from the statistics, and transmitting the display data according to the adjusted output resolution, the non-transitory computer readable storage medium in the embodiment is capable of reducing the system power consumption for the mobile device effectively.

In order to realize the above embodiment, there is further proposed a computer program product. When instructions in the computer program product are executed by a processor, a transmission method of display data is executed, the method comprises: performing statistics on the number of pixel points in display data based on grayscale; adjusting an initial output resolution according to a result obtained from the statistics; transmitting the display data according to an adjusted output resolution.

By performing statistics on the number of the pixel points in the display data based on the grayscale, adjusting the initial output resolution according to the result obtained from the statistics, and transmitting the display data according to the adjusted output resolution, the computer program product in the embodiment is capable of reducing the system power consumption for the mobile device effectively.

It needs to indicate that in the description of the present disclosure, terms of “first” and “second” or the like are just used for the purpose of description, and cannot be understood as indicating or suggesting relative importance. Additionally, in the description of the present disclosure, unless otherwise specified, “a plurality of” means two or more than two.

Any process or method in flow diagrams or described in other manners can be understood as representing modules, segments or parts of codes of executable instructions including one or more steps used for realizing specific logic functions or processes, and the scope of preferable implementations of the present disclosure comprises additional realizations, which can be implemented not in an order as shown or as discussed, and comprises executing the functions in an almost simultaneously manner or in a reverse order according to the involved functions, which shall be understood by those skilled in the art in the embodiments of the present disclosure.

It shall be understood that respective parts of the present disclosure can be realized by a hardware, a software, a firmware or a combination of the above. In the above implementations. A plurality of steps or methods can be realized by software or firmware which is stored in the storage and executed by an appropriate instruction execution system. For example, if a step or a method is realized by hardware, as the same as the mode in another implementation, it can be realized by any one of following arts commonly known in the art or combination thereof: a discreet logic circuit having a logic gate circuit used for realizing the logic function for the data signal, a specific integrated circuit having an appropriate combined logic gate circuit, a programmable gate array (PGA), a field programmable gate array (FPGA), etc.

Those ordinary skilled in the art can understand that implementation of all or part of steps of the methods in the above embodiments can be completed by instructing relative hardware through programs. The programs can be stored in a computer readable storage medium. When the programs are executed, it comprises one of steps of the method embodiments or combination thereof.

In addition, respective function units in respective embodiments of the present disclosure can be integrated in one processing module, or can exist physically as a separate unit, or can be that two or more than two units are integrated in one module. The above integrated module can be realized in a form of hardware, or can be realized in a form of software function module. When the integrated module is realized in a form of a software functional module and sold or used as an independent product, it can also be stored in one computer readable storage medium.

The above mentioned storage medium can be a read-only memory, a magnetic disk or an optical disk.

In the description of the present specification, descriptions by referring to terms of “one embodiment”, “some embodiments”, “example”, “specific example” or “some examples” mean to combine with specific features, structures, materials or characteristics described in the embodiment of the example to be included in at least one embodiments or examples of the present disclosure. In the specification, schematic expressions of the above terms do not necessarily refer to the same embodiment or example. Furthermore, the specific features, structures, materials or characteristics described above can be combined in any one or more embodiments or examples in an appropriate way.

Although the embodiments of the present disclosure have been shown and described above, it could be understood that the above embodiments are just for illustration, and cannot be understood as limitations to the present disclosure. Those ordinary skilled in the art can make alternations, amendments, replacement and modifications to the above embodiments with the scope of the present disclosure.

What is claimed is:

1. A transmission method of display data, comprising following steps:
performing statistics on the number of pixel points for the display data based on grayscale;
adjusting an initial output resolution according to a result obtained from the statistics;
transmitting the display data according to an adjusted output resolution.

2. The transmission method of display data according to claim 1, wherein performing statistics on the number of pixel points for the display data based on grayscale comprises:
performing statistics on the number of pixels for the display data whose grayscale is smaller than or equal to a first grayscale threshold value, to obtain a first count;
performing statistics on the number of pixels for the display data whose grayscale is greater than the first grayscale threshold value and smaller than or equal to a second grayscale threshold value, to obtain a second count, wherein the first grayscale threshold value is smaller than the second grayscale threshold value;
performing statistics on the number of pixels for the display data whose grayscale is greater than the second grayscale threshold value, to obtain a third count.

3. The transmission method of display data according to claim 2, wherein the adjusting an initial output resolution according to a result obtained from the statistics comprises:
determining one statistical case to which the result belongs among a plurality of statistical cases including a first statistical case, a second statistical case, a third statistical case, and a fourth statistical case, wherein the first statistical case is that the first count is the maximum value of the three counts; the second statistical case is that the second count is the maximum value of the three counts and the second count is greater than or equal to a predetermined threshold value; the third statistical case is that the third count is the maximum value of the three counts; and the fourth statistical case is that the second count is the maximum value of the three counts and the second count is smaller than the predetermined threshold value;
adjusting the initial output resolution into a first predetermined output resolution and taking the first predetermined output resolution as an adjusted output resolution if the result is the first statistical case;
not adjusting the initial output resolution if the result is the second statistical case;
not adjusting the initial output resolution if the result is the third statistical case;
adjusting the initial output resolution into a second predetermined output resolution and taking the second predetermined output resolution as the adjusted output resolution if the result is the fourth statistical case.

4. The transmission method of display data according to claim 3, wherein the predetermined threshold value is a product of a predetermined percentage and the number of total pixels for the display data.

5. A transmission apparatus of display data, comprising:
a statistical module, configured to perform statistics on the number of pixels points for the display data based on grayscale;
an adjusting module, configured to adjust an initial output resolution according to a result obtained from the statistics;
a transmission module, configured to transmit the display data according to an adjusted output resolution.

6. The transmission apparatus of display data according to claim 5, wherein the statistical module comprises:
a first statistical sub-module, configured to perform statistics on the number of pixels for the display data whose grayscale is smaller than or equal to a first grayscale threshold value, to obtain a first count;
a second statistical sub-module, configured to perform statistics on the number of pixels for the display data whose grayscale is greater than the first grayscale threshold value and smaller than or equal to a second grayscale threshold value, to obtain a second count, wherein the first grayscale threshold value is smaller than the second grayscale threshold value;
a third statistical sub-module, configured to perform statistics on the number of pixels for the display data whose grayscale is greater than the second grayscale threshold value, to obtain a third count.

7. The transmission apparatus of display data according to claim 6, wherein the adjusting module comprises:
a determining sub-module, configured to determine one statistical case to which the result belongs among a plurality of statistical cases including a first statistical case, a second statistical case, a third statistical case, and a fourth statistical case, wherein the first statistical case is that the first count is the maximum value of the three counts; the second statistical case is that the second count is the maximum value of the three counts and the second count is greater than or equal to a predetermined threshold value; the third statistical case is that the third count is the maximum value of the three counts; and the fourth statistical case is that the second count is the maximum value of the three counts and the second count is smaller than the predetermined threshold value;
an adjusting sub-module, configured to:
adjust the initial output resolution into a first predetermined output resolution and take the first predetermined output resolution as an adjusted output resolution if the result is the first statistical case;
not adjust the initial output resolution if the result is the second statistical case;
not adjust the initial output resolution if the result is the third statistical case;
adjust the initial output resolution into a second predetermined output resolution and take the second predetermined output resolution as the adjusted output resolution if the result is the fourth statistical case.

8. The transmission apparatus of display data according to claim 7, wherein the predetermined threshold value is a product of a predetermined percentage and the number of total pixels for the display data.

9. A computer program product for executing a transmission method of display data when instructions in the computer program product are executed by a processor, the method comprises:
performing statistics on the number of pixel points for the display data based on grayscale;
adjusting an initial output resolution according to a result obtained from the statistics;
transmitting the display data according to an adjusted output resolution.

10. The computer program product according to claim 9, wherein performing statistics on the number of pixel points for the display data based on grayscale comprises:
performing statistics on the number of pixels for the display data whose grayscale is smaller than or equal to a first grayscale threshold value, to obtain a first count;
performing statistics on the number of pixels for the display data whose grayscale is greater than the first grayscale threshold value and smaller than or equal to a second grayscale threshold value, to obtain a second count, wherein the first grayscale threshold value is smaller than the second grayscale threshold value;
performing statistics on the number of pixels for the display data whose grayscale is greater than the second grayscale threshold value, to obtain a third count.

11. The computer program product according to claim 10, wherein the adjusting an initial output resolution according to a result obtained from the statistics comprises:
determining one statistical case to which the result belongs among a plurality of statistical cases including a first statistical case, a second statistical case, a third statistical case, and a fourth statistical case, wherein the first statistical case is that the first count is the maximum value of the three counts; the second statistical case is that the second count is the maximum value of the three counts and the second count is greater than or equal to a predetermined threshold value; the third statistical case is that the third count is the maximum value of the three counts; and the fourth statistical case is that the second count is the maximum value of the three counts and the second count is smaller than the predetermined threshold value;
adjusting the initial output resolution into a first predetermined output resolution and taking the first predetermined output resolution as an adjusted output resolution if the result is the first statistical case;
not adjusting the initial output resolution if the result is the second statistical case;
not adjusting the initial output resolution if the result is the third statistical case;
adjusting the initial output resolution into a second predetermined output resolution and taking the second predetermined output resolution as the adjusted output resolution if the result is the fourth statistical case.

12. The computer program product according to claim 11, wherein the predetermined threshold value is a product of a predetermined percentage and the number of total pixels for the display data.
